(19) United States
(12) Patent Application Publication
(10) Pub. No.: US 2007/0156424 A1
(43) Pub. Date: Jul. 5, 2007

(54) Tool and method for quantifying product technical merit to facilitate product selection

(75) Inventors: Richard John Keck, Houston, TX (US); Hauhua Lee, Houston, TX (US); Robert Allen Baten, Baytown, TX (US)

Correspondence Address: NIXON & VANDERHYE P.C., 901 NORTH GLEBE ROAD, 11TH FLOOR, ARLINGTON, VA, 22203, US

(73) Assignee: General Electric Company, Schenectady, NY (US)

(21) Appl. No.: 11/322,361

(22) Filed: Jan. 3, 2006

(51) Int. Cl. G06Q 30/00

(52) U.S. Cl. 705/1

(57) ABSTRACT

A technical merit index tool establishes qualification thresholds to facilitate product selection. The technical merit index tool includes a technical user input section including defined selection factors and desired values for each of the selection factors for a product to be selected. A product supplier input section includes product specifications relating to the defined selection factors. A processor determines a technical merit index for each candidate product based on a summation of normalized product specifications for each of the defined selection factors relative to the desired values. The tool and method facilitate product selection using objective criteria that is weighted based on the importance of the respective selection factors.

### RELATED APPLICATION(S)

This application is related to U.S. application Ser. No. 11/______ (attorney docket 839-1785) and U.S. application Ser. No. 11/______ (attorney docket 839-1786).

### BACKGROUND OF THE INVENTION

The invention relates to facilitating the selection of products such as engineering products and, more particularly, to a system and method that quantify a product technical merit index based on product specifications for defined selection factors relative to desired values.

Selecting components such as pumps, motors, control valves and the like for engineering systems is often a challenging task that requires substantial domain knowledge and experience. In considering products for incorporation into engineering systems, important variables differ among product suppliers, and it has been a challenge to confidently determine which product is best suited for the engineering system. For example, in selecting a hydraulic pump, important selection factors may include outlet pressure, speed, flow ratio, and the like. Available products may satisfy requirements for some of the selection criteria while falling short on others. The engineer is thus faced with the task of determining where to compromise in the desired specifications while selecting a product that would be suitable for the intended application.

### BRIEF DESCRIPTION OF THE INVENTION

In an exemplary embodiment of the invention, a method enables quantifying product technical merit to facilitate product selection. The method includes the steps of (a) identifying selection factors for a product to be selected; (b) establishing a weight factor relating to an importance level for each of the identified selection factors; (c) defining ranking criteria for each of the identified selection factors including at least two levels as high (H) and low (L); (d) determining a technical merit index for each candidate product based on a summation of normalized product specifications for each of the identified selection factors weighted by the respective weight factor and multiplied by the respective ranking criteria; and (e) selecting one of the candidate products based at least partly on a comparison the technical merit index of each candidate product.

In another exemplary embodiment of the invention, a technical merit index tool establishes qualification thresholds to facilitate product selection. The technical merit index tool includes a technical user input section including defined selection factors and desired values for each of the selection factors for a product to be selected, and a product supplier input section including product specifications relating to the defined selection factors. A processor determines a technical merit index for each candidate product based on a summation of normalized product specifications for each of the defined selection factors relative to the desired values.

### BRIEF DESCRIPTION OF THE DRAWINGS

FIG. 1 is an exemplary spreadsheet application of the technical merit index tool of the invention; and

FIG. 2 is a flow chart illustrating a usage phase and development phase for the technical merit index tool.

### DETAILED DESCRIPTION OF THE INVENTION

Technical merit index (TMI) focuses on “technical” aspect evaluations in meeting engineering requirements. Examples of technical factors include product performance such as efficiency, internal design/structure, materials of key parts, reliability information like MTBF (mean time between failure) and MTTR (mean time to repair), etc. Non-technical factors such as cost, warranty, terms and conditions, and non-technical personal-preference like color or style, etc. are intentionally left out as they are considered orthogonal to technical factors and should be evaluated in a separate dimension.

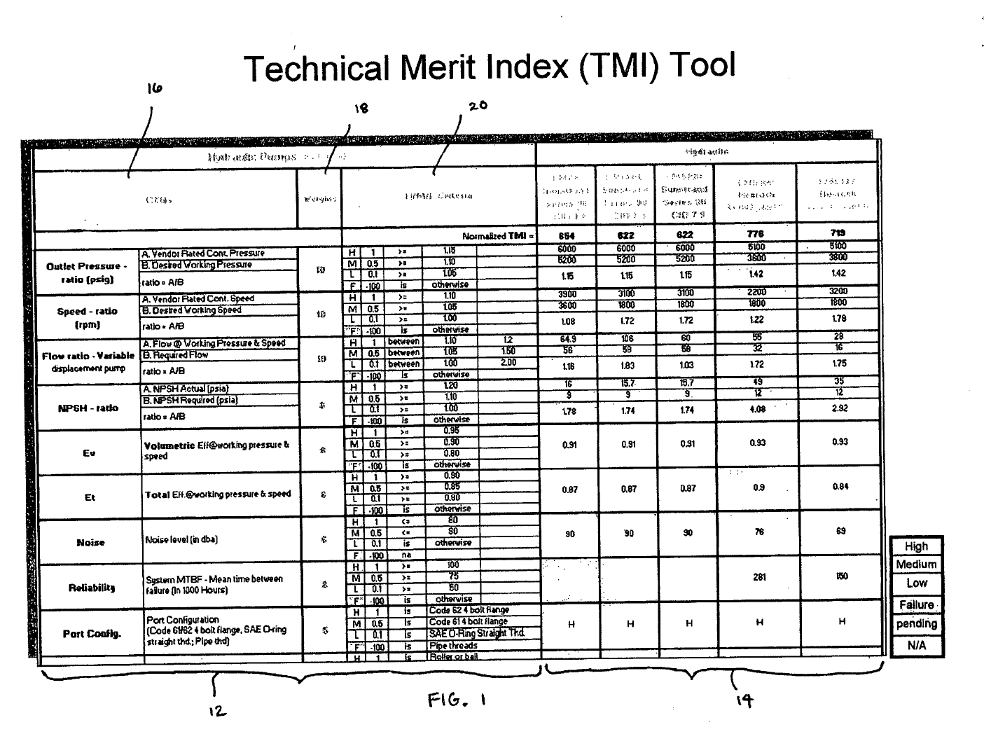

In a preferred application, TMI is defined with respect to specific engineering components and applications, such as pumps used for pumping hydraulic fluid (hydraulic pump), for pumping fuel (fuel pump), for pumping lubrication material (lube pump) or control valves for handling liquid fuel or high pressure water, and the like. FIG. 1 illustrates the TMI tool in a spreadsheet application with reference to an evaluation of hydraulic pumps. Any suitable spreadsheet application may be used, and many such applications are available; thus, details of the use and operation of a spreadsheet application will not be described. An exemplary spreadsheet application suitable for the TMI tool of the invention is an Excel-based application. In such an application, data input into the input cells of the spreadsheet are processed via a processor such as a macro VBA function according to user-input data.

With reference to FIG. 1, the TMI tool includes a technical user input section 12 and a product supplier section 14. The technical user input section 12 includes defined selection factors and desired values for each of the selection factors for a product to be selected. These data are input on the user side by experienced personnel, such as senior engineers or the like for engineering products.

As shown in FIG. 1, the technical user input section 12 lists a plurality of identified critical selection factors 16 for the target component and application. For each of the identified selection factors 16, a weight factor 18 relating to an importance level is established. The weight factors 18 may vary from, for example, 1-10, with 10 being a maximum for an indication that the particular selection factor is of maximum importance in selecting the product.

The technical user input section 12 also includes ranking criteria 20 defined for each of the identified selection factors 16. The ranking factors establish boundaries and tolerances around the desired value for each of the selection factors 16. For example, in the hydraulic pump example illustrated in FIG. 1, a selection factor of maximum importance (indicated by the weight factor 18 listed as ‘10’) is an outlet pressure ratio, which is listed as a ratio of the vendor rated continuous pressure to the desired working pressure. The ranking criteria 20 are divided into high (H), medium (M), low (L) and fail (F), although more or fewer ranking criteria may be utilized. The experienced personnel determine what values of outlet pressure ratio would fall under which ranking criteria. In the example shown in FIG. 1, an outlet pressure ratio greater than or equal to 1.15 is considered high (H), a pressure ratio within the range of [1.1, 1.15] is considered medium (M), an outlet pressure ratio within the range of [1.05, 1.1] is considered low (L), and any outlet pressure ratio less than 1.05 is considered fail (F). The ranking criteria 20 includes a multiplication factor for each ranking, which in the example shown is H=1, M=0.5, L=0.1, and F=−100. These values, of course, could be varied by application or customized for each selection factor 16. In this manner, products having specifications that meet or exceed more important selection factors will be favored in the technical merit index analysis.

The product supplier input section 14 includes product specifications typically provided by the product supplier relating to each of the defined selection factors 16. In the example shown in FIG. 1, there are five hydraulic pump candidates being considered. The selection factor data, such as outlet pressure ratio, is provided by the supplier. With the data input into the spreadsheet, candidate products are evaluated against the predefined ranking criteria 20 for each of the selection factors 16, and the TMI tool obtains TMI scores via a weighted summation of all grades. The raw scores are then normalized to between 0 and 1000, where ‘1000’ represents a perfect score where the candidate is rated ‘H’ for every selection factor 16. A ‘0’ results from the case where at least one of the selection factors 16 is rated ‘F’. If all of the selection factors 16 are rated ‘M’, the score would fall around 500. If all of the selection factors are rated ‘L’, the score would fall around 100.

In analyzing the technical merit index for each of the candidate products, engineering personnel may define a technical qualification threshold as a minimum acceptable technical merit index based on use experience including both success and failure cases and possibly additional statistical analysis such as a linear regression model of the success/failure cases. In the example shown in FIG. 1, assuming a technical qualification threshold was set at TMI=650, two of the candidate products would be immediately disqualified. Subsequently, the remaining candidate products can be evaluated based on engineer experience with a particular product or brand, or other non-technical factors such as cost, etc. discussed above.

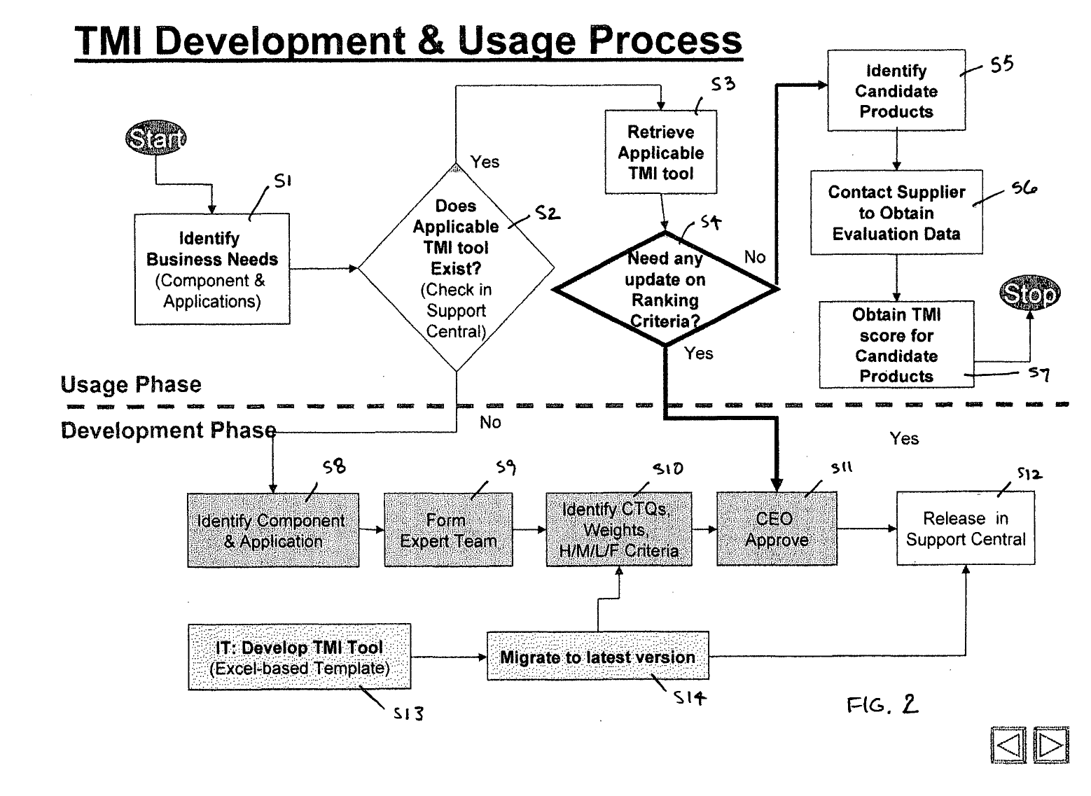

FIG. 2 is a flow chart illustrating a usage phase and development phase of the technical merit index tool. After a business need for a particular component and its application is identified (step S1), a determination is made whether an applicable TMI tool already exists (step S2). If not, the TMI tool for the desired product is developed in a development phase (discussed in more detail below). If so (YES in step S2), the applicable TMI tool is retrieved (step S3), and it is validated whether the selection factors and ranking criteria are all up to date and reflecting the latest technology available (example of such needs is in selecting personal computer, the ranking criteria for CPU and memory should reflect the newest technology) (step S4). If so (YES in step S4), updates are input and appropriate approvals are obtained (step S11), and the updated TMI tool is released for access and use (step S12). If updates are not necessary (NO in step S4), candidate products are identified (step S5). The product supplier input section 14 is then populated with product data from the supplier (step S6). The tool then obtains TMI scores for the candidate products (step S7), and an evaluation and selection of the candidate product can be carried out.

If an applicable TMI tool does not exist (NO in step S2), the TMI tool can be developed in a development phase where the component and application are identified (step S8), and a team of experienced personnel or “expert team” is formed to identify critical selection factors 16, weight factors 18, and ranking criteria 20 (steps S9 and S10). Appropriate approvals are obtained (step S11), and the TMI tool is released for access and use (step S12).

From a technical standpoint in the development phase, the TMI tool is developed using a known spreadsheet product (step S13) and the tool can be customized to different applications (step S14).

With the TMI tool and method, the technical effect is to facilitate the selection of candidate products based on a more objective analysis than previously accomplished.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. A method of quantifying product technical merit to facilitate product selection, the method comprising:
(a) identifying selection factors for a product to be selected;
(b) establishing a weight factor relating to an importance level for each of the identified selection factors;
(c) defining ranking criteria for each of the identified selection factors including at least two levels as high (H) and low (L);
(d) determining a technical merit index for each candidate product based on a summation of normalized product specifications for each of the identified selection factors weighted by the respective weight factor and multiplied by the respective ranking criteria; and
(e) selecting one of the candidate products based at least partly on a comparison the technical merit index of each candidate product.

2. A method according to claim 1, wherein step (c) is practiced by defining ranking criteria for each of the identified selection factors including high (H), medium (M), low (L) and fail (F).

3. A method according to claim 2, wherein the ranking criteria for each level is H=1, M=0.5, L=0.1, and F=−100.

4. A method according to claim 1, wherein step (e) is practiced by selecting one of the candidate products based solely on technical factors.

5. A method according to claim 1, wherein step (e) is practiced by selecting one of the candidate products based on both technical factors and non-technical factors.

6. A method according to claim 1, further comprising, prior to step (e), defining a technical qualification threshold as a minimum acceptable technical merit index based on use experience.

7. A method according to claim 6, wherein step (e) is practiced by eliminating candidate products having a technical merit index below the technical qualification threshold and comparing remaining candidate products based on non-technical factors.

8. A technical merit index tool for establishing qualification thresholds to facilitate product selection, the technical merit index tool comprising:
a technical user input section including defined selection factors and desired values for each of the selection factors for a product to be selected;
a product supplier input section including product specifications relating to the defined selection factors; and
a processor that determines a technical merit index for each candidate product based on a summation of normalized product specifications for each of the defined selection factors relative to the desired values.

9. A technical merit index tool according to claim 8, wherein the selection factors are weighted based on a weight factor corresponding to an importance level.

10. A technical merit index tool according to claim 9, wherein the desired values comprise ranking criteria for each of the identified selection factors including at least two levels as high (H) and low (L).

11. A technical merit index tool according to claim 10, wherein the ranking criteria for each of the identified selection factors comprises high (H), medium (M), low (L) and fail (F).

12. A technical merit index tool according to claim 11, wherein the ranking criteria factor for each level is H=1, M=0.5, L=0.1, and F=−100.
